(19) United States
(12) Patent Application Publication
(10) Pub. No.: US 2026/0105902 A1
(43) Pub. Date: Apr. 16, 2026

(54) HAPTIC DEVICE MANAGER AND SYSTEM

(71) Applicant: YOUNG TALENTED PIONEERS CANADA INC., Coquitlam (CA)

(72) Inventors: Hessam MALEKI, Coquitlam (CA); Sobhan SANAEE, Plano, TX (US); Payam PAJOOHI, Plano, TX (US); Payvand PAJOOHI, Richardson, TX (US); Kanz KAYFAN, McKinney, TX (US)

(21) Appl. No.: 19/355,533

(22) Filed: Oct. 10, 2025

Related U.S. Application Data
(60) Provisional application No. 63/705,707, filed on Oct. 10, 2024.

(51) Int. Cl. G10H 1/40; G08B 6/00; H04W 56/00

(52) U.S. Cl. CPC G10H 1/40; G08B 6/00; H04W 56/00

(57) ABSTRACT

Herein is disclosed various methods and systems for haptic device managers and haptic device systems. One aspect of the invention provides a haptic device manager comprising: a low-power wireless transmitter; an input device; a display; and a controller configured to: receive a haptic sequence via the input device; receive a wireless bandwidth of the low-power wireless transmitter via the input device; determine a timing message and a transmission frequency; determine a start delay; transmit the haptic sequence and the timing message to the haptic devices based on the transmission frequency; and display a visual representation of the haptic sequence starting the start delay after the first transmission of the haptic sequence and timing message by the wireless transmitter.

### CROSS-REFERENCE TO RELATED APPLICATIONS

This application claims priority from application No. 63/705,707, filed 10 Oct. 2024. For purposes of the United States, this application claims the benefit under 35 U.S.C. § 119 of application No. 63/705,707, filed 10 Oct. 2024, and entitled WEARABLE BEAT GENERATING APPARATUS which is hereby incorporated herein by reference for all purposes.

### Technical Field

The present disclosure is directed to a haptic device manager, and a synchronous haptic device system. More particularly, the present disclosure is directed to a haptic device manager, and a synchronous haptic device system, for a plurality of haptic devices outputting a haptic musical beat.

### BACKGROUND

Various activities involve synchronizing physical movements or actions. A periodic signal, often referred to as a beat, can be used to assist participants in synchronizing their movements or actions.

For example, when a performer plays a musical instrument or sings, the performer may require assistance in keeping their performance with a musical beat. Such assistance may aid the performer during practice or during a performance.

The need for assistance in keeping with a musical beat may be exasperated when multiple musicians perform together. For example, multiple musicians in a band may require assistance in keeping the timing of their performances with a common musical beat, thereby synchronizing their performances.

Metronomes may be used to communicate a musical beat to a musician. Most conventional metronomes are either standalone devices, or software applications running on mobile devices such as smartphones. In either case, the metronome typically communicates the beat via an audio signal.

An audio signal communicating a musical beat is limited in how many performers can receive the audio signal. Given the saturated audio environment of many musical performances, a single audio signal may only be heard by a limited number of performers.

Furthermore, an audio signal communicating a musical beat is generally undesirable during a musical performance, because of a desire to avoid having the audio signal be heard during to the musical performance.

There is a general desire for an improved metronome. Furthermore, there is a general desire for an improved metronome that may communicate a musical beat to a number of musical performers, without being heard during a musical performance.

The foregoing examples of the related art and limitations related thereto are intended to be illustrative and not exclusive. Other limitations of the related art will become apparent to those of skill in the art upon a reading of the specification and a study of the drawings.

### SUMMARY

Further aspects and example embodiments are illustrated in the accompanying drawings and/or described in the following description.

One aspect of the invention provides a wearable metronome comprising: a wearable enclosure: an antenna mounted to the wearable enclosure; an haptic module mounted within the wearable enclosure; and a wearable controller mounted within the wearable enclosure and configured to receive a signal from a central controller via the antenna and control the haptic module to output a beat In addition to the exemplary aspects and embodiments described above, further aspects and embodiments will become apparent by reference to the drawings and by study of the following detailed descriptions.

One aspect of the invention provides a haptic device manager for synchronizing a display output with a plurality of haptic outputs of a respective plurality of haptic devices, the haptic device manager comprising: a low-power wireless transmitter; an input device; a display; and a controller configured to: receive a haptic sequence via the input device; receive a wireless bandwidth of the low-power wireless transmitter via the input device; determine a timing message and a transmission frequency based on the haptic sequence; determine a start delay based on the wireless bandwidth and the timing message; transmit, via the wireless transmitter, the haptic sequence and the timing message to the haptic devices based on the transmission frequency; and display, via the display, a visual representation of the haptic sequence starting the start delay after the first transmission of the haptic sequence and timing message by the wireless transmitter.

In some embodiments, receiving the haptic sequence via the input device comprises: displaying, via the display, a plurality of haptic sequences; and receiving, via the input device, a selected one of the plurality of haptic sequences; and transmitting, via the wireless transmitter, the haptic sequence to the haptic devices comprises: transmitting, via the wireless transmitter, a haptic sequence identifier to the haptic devices, wherein the haptic sequence identifier corresponds to the selected one of the plurality of haptic sequences.

In some embodiments, the haptic sequence comprises a repeating musical bar having a plurality of beats, the timing message comprises one beat of the plurality of beats, and the timing frequency corresponds to the frequency of the musical bar.

In some embodiments, determining the timing message and the transmission frequency comprises determining the timing message and the transmission frequency based on a maximum variance between the visual representation of the haptic sequence and the plurality of haptic outputs of the respective plurality of haptic devices.

In some embodiments, determining the start delay comprises: determining a packet size based on the haptic sequence and the timing message; determining a bitrate based on the wireless bandwidth; and determining the start delay based on the packet size and the bitrate.

In some embodiments, the low-power wireless transmitter comprises a wireless transmitter with an output power of 30 decibel-milliwatts (dBm) or less, and a frequency band between 902 megahertz (MHz) and 928 MHz.

In some embodiments, the haptic device manager further comprises a haptic output device, and the controller is further configured to output the haptic sequence via the haptic output device starting the start delay after the first transmission of the haptic sequence and timing message by the wireless transmitter.

In some embodiments, the input device comprises a twelve-key keypad; the display comprises a thin-film-transistor liquid-crystal display (TFT LCD) display; and the haptic device manager further comprises a rechargeable battery power supply, and the power supply powers the input device, display, controller, and low-power wireless transmitter.

One aspect of the invention provides a synchronous haptic device system comprising a haptic device manager and a plurality of haptic devices, wherein: the haptic device manager comprises a haptic device manager as otherwise described herein; each of the haptic devices comprises: a low-power wireless receiver; a haptic output device; and a controller configured to: receive the haptic sequence and the timing message from the low-power wireless transmitter of the haptic device manager, and control the haptic output device based on the haptic sequence and the timing message.

In some embodiments, the haptic sequence comprises a repeating musical bar having a plurality of beats, the timing message comprises one beat of the plurality of beats, and the timing frequency corresponds to the frequency of the musical bar; and the controller of each of the haptic devices is configured to: repeatedly output, via the haptic output device, the plurality of beats of the musical bar; and synchronize a one of the plurality of beats to the timing message.

In some embodiments, the haptic sequence comprises a repeating musical bar having a plurality of beats; receiving the haptic sequence via the input device comprises: displaying, via the display, a plurality of musical bars; and receiving, via the input device, a selected one of the plurality of musical bars; transmitting, via the wireless transmitter, the haptic sequence to the haptic devices comprises: transmitting, via the wireless transmitter, a musical bar identifier to the haptic devices, wherein the musical bar identifier corresponds to the selected one of the plurality of musical bars; and the controller of each of the haptic devices is further configured to: generate the selected one of the plurality of musical bars from the musical bars identifier; repeatedly output, via the haptic output device, the plurality of beats of the selected one of the plurality of musical bar; and synchronize a one of the plurality of beats to the timing message.

In some embodiments, each of the haptic devices comprises a crystal oscillator having a crystal output frequency, and the controller of each of the haptic devices is further configured to tune the crystal output frequency by adjusting a capacitance of a capacitor connected to the crystal oscillator.

In some embodiments, the low-power wireless receiver comprises a wireless receiver with a sensitivity of at least −138 decibel-milliwatts (dBm).

In some embodiments, the haptic devices comprise wrist-wearable haptic devices, and the output of the haptic output devices comprises vibrations.

One aspect of the invention provides a method of synchronizing a display output of a haptic device manager with a plurality of haptic outputs of a respective plurality of haptic devices, the method comprising: receiving, via an input device of the haptic device manager, a haptic sequence; receiving, via the input device of the haptic device manager, a wireless bandwidth of a low-power wireless transmitter of the haptic device manager; determining, via a controller of the haptic device manager, a timing message and a transmission frequency based on the haptic sequence; determine, via a controller of the haptic device manager, a start delay based on the wireless bandwidth and the set of timing messages; transmitting, via the low-power wireless transmitter of the haptic device manager, the haptic sequence and the timing message to the haptic devices based on the transmission frequency; and displaying, via a display of the haptic device manager, a visual representation of the haptic sequence starting the start delay after the first transmission of the haptic sequence and timing message by the wireless transmitter.

In some embodiments, receiving, via the input device of the haptic device manager, the haptic sequence comprises: displaying, via the display of the haptic device manager, a plurality of haptic sequences; and receiving, via the input device of the haptic device manager, a selected one of the plurality of haptic sequences; and transmitting, via the low-power wireless transmitter of the haptic device manager, the haptic sequence and the timing messages to the haptic devices according to the transmission schedule comprises: transmitting, via the low-power wireless transmitter of the haptic device manager, a haptic sequence identifier to the haptic devices, wherein the haptic sequence identifier corresponds to the selected one of the plurality of haptic sequences.

In some embodiments, the haptic sequence comprises a repeating musical bar having a plurality of beats, the timing message comprises one beat of the plurality of beats, and the timing frequency corresponds to the frequency of the musical bar.

In some embodiments, determining the start delay comprises: determining, via a controller of the haptic device manager, a packet size based on the haptic sequence and the timing message; determining, via a controller of the haptic device manager, a bitrate based on the wireless bandwidth; and determining, via a controller of the haptic device manager, the start delay based on the packet size and the bitrate.

Some embodiments further comprise receiving, via a low-power wireless receiver of each of the haptic devices, the haptic sequence and the timing message; outputting, via a haptic output device of each of the haptic devices, the haptic sequence synchronized to the timing message.

In some embodiments, the haptic sequence comprises a repeating musical bar having a plurality of beats; the timing message comprises one beat of the plurality of beats; transmitting the haptic sequence to the haptic devices comprises transmitting a musical bar identifier to the haptic devices, wherein the musical bar identifier corresponds to the musical bar; and outputting the haptic sequence synchronized to the timing message comprises: generating the musical bar from the musical bar identifier; outputting the plurality of beats of the musical bar; and synchronizing a one of the plurality of beats of the musical bar to the timing message.

### BRIEF DESCRIPTION OF THE DRAWINGS

The accompanying drawings illustrate non-limiting example embodiments of the invention.

FIG. 1 is a schematic diagram of a haptic device manager and a plurality of haptic devices, according to an example embodiment of the present invention.

FIG. 2 is a block diagram of a method for synchronizing a display output of a haptic device manager with a plurality of haptic outputs of a respective plurality of haptic devices, according to an example embodiment of the present.

FIG. 3A is a schematic diagram of a button controller according to an example embodiment of the present invention.

FIG. 3B is a schematic diagram of a battery charger according to an example embodiment of the present invention.

FIGS. 4A to 4C are schematic diagram of a haptic device manager according to an example embodiment of the present invention.

FIGS. 5A to 5C are a schematic diagram of a haptic device according to an example embodiment of the present invention.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

Herein is disclosed various methods, systems, and apparatus for synchronous haptic devices. Some embodiments comprise a haptic device manager for synchronizing a display output with a plurality of haptic outputs of a respective plurality of haptic devices. Some embodiments comprise a synchronous haptic device system comprising a haptic device manager and a plurality of haptic devices. Some embodiments comprise a method of synchronizing a display output of a haptic device manager with a plurality of haptic outputs of a respective plurality of haptic devices.

Haptic devices, including wearable haptic devices like wrist-wearable haptic devices, can be used to communicate various sequences via their haptic output. For example, a haptic device can be used to communicate a musical sequence such as a musical beat. In some embodiments, a haptic device may comprise a haptic actuator for generating physical vibrations, and the musical beat is communicated through physical vibrations generated by the haptic actuator. Examples of haptic actuators include Eccentric Rotating Mass (ERM) motors, Linear Resonant Actuators (LRAs), and audio speakers.

Where multiple participants intend to synchronize their activities, for example multiple musicians intending to synchronize their musical performances, the participants may use multiple timing devices to assist in synchronizing their activity. Using multiple timing devices requires some mechanism to ensure that the timing devices themselves are synchronized in order for each participant to be synchronizing their activity to the same sequence. One or more embodiments of the present invention provide a haptic device manager for synchronizing a display output of the haptic device manager with a plurality of haptic outputs of a respective plurality of haptic devices.

The number of haptic devices required for a group of participants is directly proportional to the size of the group of participants. As such, for larger groups of participants, there is need for low-cost haptic devices in order for the haptic devices to be cost effective for the group. However, many components suitable for wearable devices, for example displays, input devices, and wireless modules typically used in wearable devices substantially increase the cost of such wearable devices. In particular, the wireless transmitters, receivers, and antennae used in wearable devices may substantially increase the cost of such devices. The power requirements of typical wireless transmitters, receivers, and antennae used in wearable devices requires costly power supplies, for example high-capacity and high-power batteries. As such, typical wearable haptic devices may be too costly for certain group uses, for example groups of casual musicians.

One or more embodiments of the present invention provide a synchronous haptic device system comprising a haptic device manager and a plurality of haptic devices, wherein the haptic device manager and haptic devices communicate via a low-power communications protocol using one or both of low-power wireless transmitters and low-power wireless receivers. Such low-power wireless transmitters and receivers may be more cost effective than other wireless transmitters and receivers, and have reduces power requirements over other wireless transmitters and receivers, thereby permitting such haptic devices to use more cost effective power supplies.

Low-power wireless communications protocols, for example the LoRa™ communications protocol, may have reduced power requirements over other wireless communications protocols. However, the lower the power requirement of a wireless communications protocol, typically the lower the bandwidth of the wireless communications protocol. As such, one or more embodiments of the present invention provide a synchronous haptic device system wherein a haptic device manager communicates with a plurality of haptic devices using limited bandwidth. In some embodiments, the bandwidth may be so limited that a complete sequence, for example a complete musical beat, cannot be transmitted via the wireless communications protocol. In such embodiments, the synchronous haptic device system transmits only a portion of the sequence, or musical beat, required to synchronize the sequence, or musical beat, between the haptic device manager and plurality of haptic devices.

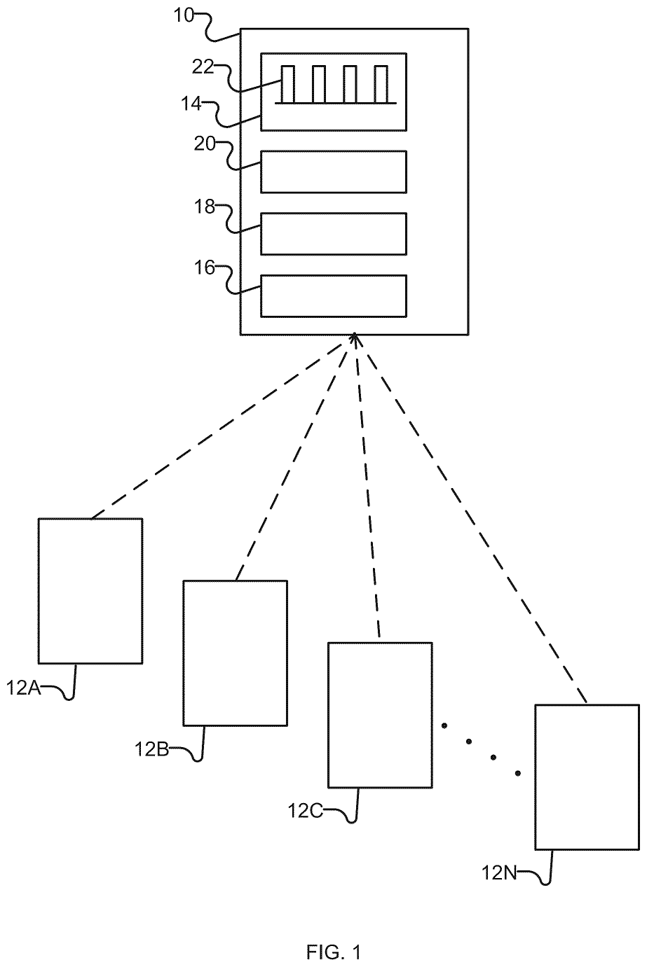

FIG. 1 is a schematic diagram of haptic device manager 10 and plurality of haptic devices 12A, 12B, 12C, 12N (collectively, haptic devices 12), wherein haptic device manager 10 synchronizes display output 22 of haptic device manager display 14 with a plurality of haptic outputs of haptic devices 12. FIG. 1A depicts haptic devices 12A, 12B, 12C, 12N to denote haptic devices 12 may comprise “N” number of individual haptic devices.

Haptic device manager 10 comprises low power wireless transmitter 16, input device 18, display 14, and controller 20. Controller 20 is configured to:
receive a haptic sequence via input device 18;
receive a wireless bandwidth of low-power wireless transmitter 16 via input device 18;
determine a timing message and a transmission frequency based on the haptic sequence;
determine a start delay based on the wireless bandwidth and the timing message;
transmit, via wireless transmitter 16, the haptic sequence and the timing message to haptic devices 12 based on the transmission frequency; and
display, via display 14, visual representation 22 of the haptic sequence starting the start delay after the first transmission of the haptic sequence and timing message by the wireless transmitter.

In some embodiments, receiving the haptic sequence via input device 18 comprises: displaying, via display 14, a plurality of haptic sequences and receiving, via input device 18, a selected one of the plurality of haptic sequences. In such embodiments, transmitting, via wireless transmitter 16, the haptic sequence to haptic devices 12 may comprise: transmitting, via wireless transmitter 16, a haptic sequence identifier to the haptic devices, wherein the haptic sequence identifier corresponds to the selected one of the plurality of haptic sequences.

In some embodiments, the haptic sequence comprises a repeating musical bar having a plurality of beats, the timing message comprises one beat of the plurality of beats, and the timing frequency corresponds to the frequency of the musical bar. For example, the haptic sequence may be a repeating 4/4 musical bar, and the timing messages may comprise the first beat of the 4/4 musical bar. In a further example, the haptic sequence may be a 3/4 musical bar, and the timing messages may comprise the first beat of the 3/4 musical bar.

In some embodiments, determining the timing message and the transmission frequency comprises determining the timing message and the transmission frequency based on a maximum variance between the visual representation of the haptic sequence and the plurality of haptic outputs of respective plurality of haptic devices 12. In some embodiments, the maximum variance may be 100 milliseconds (ms), 20 ms, or 10 ms.

Haptic device manager 10 may determine the start delay based on the haptic sequence and the timing message. For example, determining the start delay may comprise: determining a packet size based on the haptic sequence and the timing message; determining a bitrate based on the wireless bandwidth; and determining the start delay based on the packet size and the bitrate.

Low power wireless transmitter 16 may comprise a wireless transmitter with an output power of up to 30 decibel-milliwatts (dBm). In some embodiments, a frequency band of low power wireless transmitter 16 is between 902 megahertz (MHz) and 928 MHz.

Haptic device manager 10 may comprise a haptic output device, and controller 20 may be further configured to output the haptic sequence via the haptic output device starting the start delay after the first transmission of the haptic sequence and timing message. In such embodiments, haptic device manager 10 provides a haptic output synchronized with the haptic output of haptic devices 12.

In one or more embodiments of haptic device manager 10:
input device 18 comprises a twelve-key keypad;
display 14 comprises a thin-film-transistor liquid-crystal display (TFT LCD) display; and/or
haptic device manager 10 further comprises a rechargeable battery power supply, and the power supply powers input device 18, display 14, controller 20, and low-power wireless transmitter 16.

Some embodiments of the present invention may provide a haptic device system comprising haptic device manager 10 and plurality of haptic devices 12. Each of haptic devices 12 may comprise a low-power wireless receiver, a haptic output device, and a controller. The controller of each of haptic devices 12 may be configured to receive the haptic sequence and the timing message from low-power wireless transmitter 16 of haptic device manager 10, and control the haptic output device based on the haptic sequence and the timing message.

Where the haptic sequence comprises a repeating musical bar having a plurality of beats, and the timing message comprises one beat of the plurality of beats, each of the controllers of haptic devices 12 may be configured to repeatedly output, via the haptic output device, the plurality of beats of the musical bar, and synchronize a one of the plurality of beats to the timing message.

In some embodiments, each of haptic devices 12 comprises a crystal oscillator having a crystal output frequency, and the controller of each of haptic devices 12 is further configured to tune the crystal output frequency by adjusting a capacitance of a capacitor connected to the crystal oscillator Haptic devices 12 may comprise wrist-wearable haptic devices, and the output of the haptic output devices may comprise vibrations.

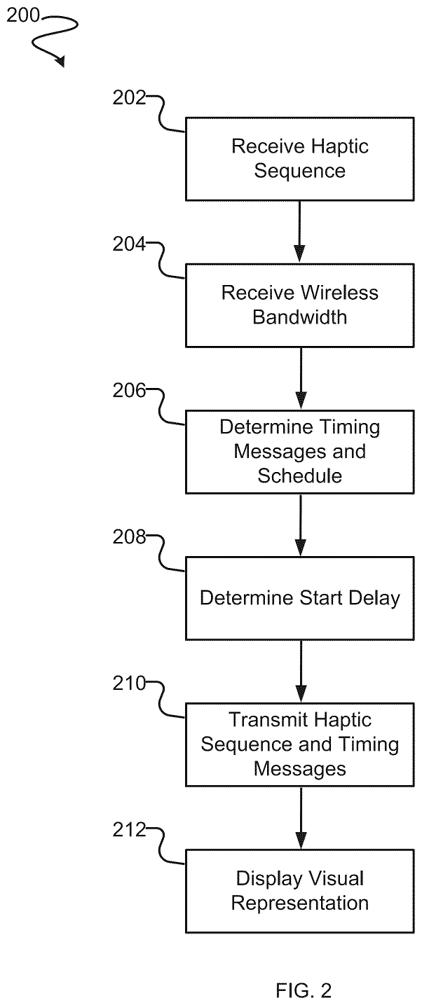

FIG. 2 is a block diagram of method 200 for synchronizing a display output of a haptic device manager with a plurality of haptic outputs of a respective plurality of haptic devices. Method 200 the comprises:
step 202: receiving, via an input device of the haptic device manager, a haptic sequence;
step 204: receiving, via the input device of the haptic device manager, a wireless bandwidth of a low-power wireless transmitter of the haptic device manager;
step 206: determining, via a controller of the haptic device manager, a timing message and a transmission frequency based on the haptic sequence;
step 208: determine, via a controller of the haptic device manager, a start delay based on the wireless bandwidth and the set of timing messages;
step 210: transmitting, via the low-power wireless transmitter of the haptic device manager, the haptic sequence and the timing message to the haptic devices based on the transmission frequency; and
step 212: displaying, via a display of the haptic device manager, a visual representation of the haptic sequence starting the start delay after the first transmission of the haptic sequence and timing message by the wireless transmitter.

In some embodiments of method 200, step 202 comprises: displaying, via the display of the haptic device manager, a plurality of haptic sequences, and receiving, via the input device of the haptic device manager, a selected one of the plurality of haptic sequences. In such embodiments, step 210 may comprise transmitting, via the low-power wireless transmitter of the haptic device manager, a haptic sequence identifier to the haptic devices, wherein the haptic sequence identifier corresponds to the selected one of the plurality of haptic sequences.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

### Some Embodiments

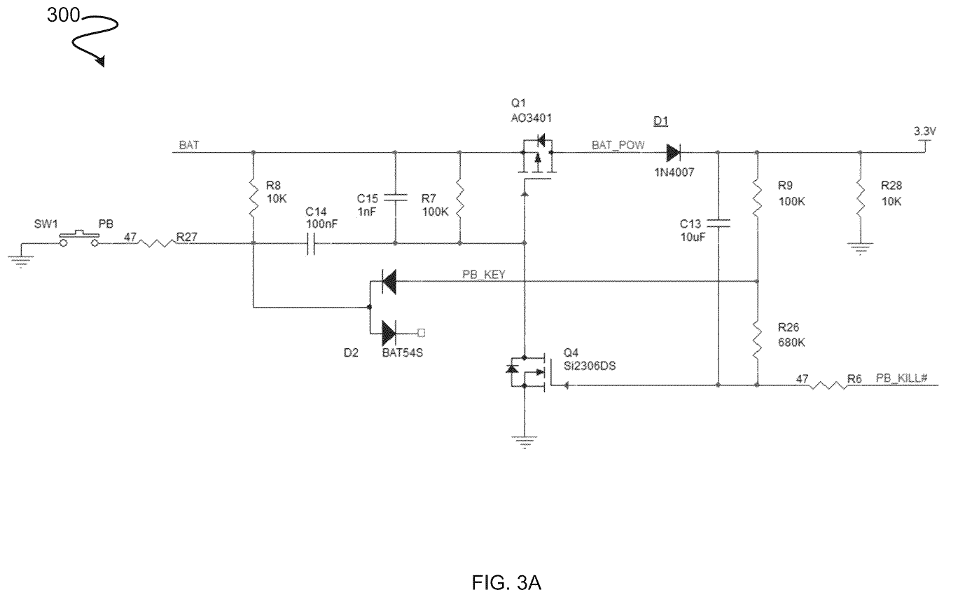

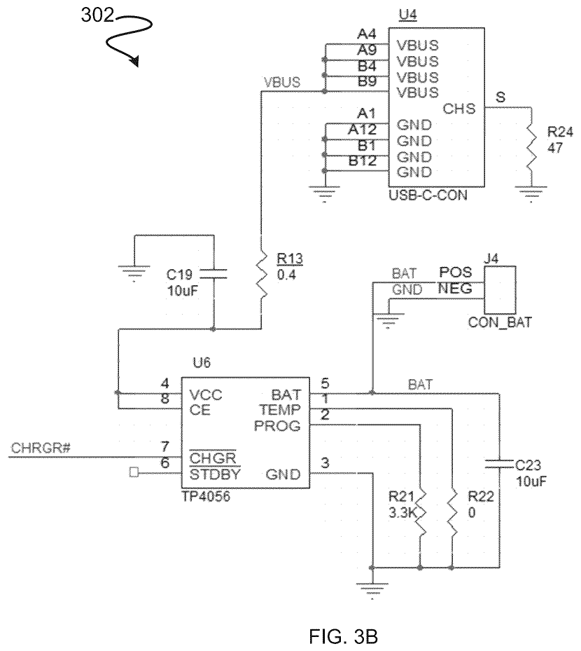

FIGS. 3A, 3B, 4A-4C, 5A and 5B are schematic diagrams of one or more features of one or more embodiments of the present invention.

FIG. 3A is a schematic diagram of button controller circuit 300 according to an example embodiment of the present invention. Button controller circuit 300 allows a circuit to be shutdown by a microcontroller. The circuit contains a switch (Q1) and a holder (Q4). A depression of the button activates switch Q1 and holder Q4 will maintain the activated status of switch Q1 after Q1 is activated. To deactivate switch Q1, a microcontroller may transmit a signal through PB_KILL to deactivate holder Q4. As such, the circuit may be activated by depressing the button and deactivated by the microcontroller. Alternatively, a long hold of push button (more than 10 seconds) will shut down the circuit, for example if the microcontroller stops responding.

Some embodiments may comprise an RF system using one or more LoRa™ transceivers (SX1261). Chirp Modulation may be used to increase receiver sensitivity, for example up to −138 dBm (decibel milliwatts). Such a sensitivity may be used for non-line of sight reception within the system for a low cost. Further components of the RF system may comprise only an antenna and a filter, thereby further reducing the cost and form factor of said system. A Chip antenna may be used to further reduce the form factor.

In embodiments comprising a crystal oscillator, an accuracy of the crystal may determine the minimum bandwidth of the system. A crystal capacitance load may be tuned by system software, and tuning of the frequency of the crystal oscillator may be performed by the system.

Some embodiments may comprise an LED indicator, wherein the LED indicator may indicate one or more of the following:
Power on/off blink.
Test mode reception indicator.
Power of frame indicator. When holding button, a blink may indicate entering a power frame and releasing the button will turn off the device.
Paring mode. Diming LED may show frequency scanning for pairing.
Battery charging. During battery charging it will light the charging in progress.

FIG. 3B is a schematic diagram of battery charger circuit 302 according to an example embodiment of the present invention. Battery charger circuit 302 comprises an ION charger chip. Battery charger circuit 302 may automatically stop charging when a battery is fully charged. The device must be on to see the charging InProgress on LED. The device will automatically turn off after charging completed. The resistor on Pin 2 of charger (R21) will set the maximum charging current. The charging connection may be USB-C type.

In embodiments where the haptic output is vibration, vibration may be used to indicate a beat, and/or to indicate power on/off. The vibration for a tack and bell can be set on master setting. It may be updated on every received packet, or timing message.

Various embodiments of the present invention may provide one or more of the following:
a wearable metronome;
a CPU controller;
a wireless receiver;
a power source;
a display such as an LED indicator;
a haptic module, for example a vibrating means such as a motor coupled to an unbalance weight; and
a central controller, for example a smartphone running a software application.

Some embodiments of the present invention may comprise one or more of the following hardware components:
CPU: STM32F030CCT6 (256K Flash, 32K SRAM)
US915 Band (902 . . . 928 MHz) Transmit only
CSS (Chirp Spread Spectrum)
Transmit power: up to 30 dBm
Serial Flash Storage for settings
Audio, vibration and buzzer output
Keypad with 12 tact switches
TFT LCD 2.4″ 320×240 with SPI interface

Hardware Components:
Keypad: Keys may be tact switches and are scanned by hardware in 10 ms loops. 10 keys for profile settings. 2 keys for start/stop and sync.
RF Module: RF Module may be a E22900M30S which contains a SX1261 chip with a power amplifier that provides up to 30 dBm output power. It contains an on module ufl connector for an antenna which may be used as an antenna connector. The RF module may work with a 5V power supply and be controlled through an SPI interface. It may be used in LoRa™ mode.
Power: Power may be provided in two stages after a battery. One stage being a step up to 5V which provides the board independent of battery voltage, and one stage being a step down to provide CPU power. Step up to 5V efficiency is more than %90 and it will be used for RF module. The step down LDO may have %66 efficiency to provide 3.3V for a CPU and an LCD. Battery charger may comprise a TP4056 that automatically stops charging after full charge. The charging process may be proceeded with a device switch turned on or off. If the device is turned on, the charging may never stop (because of continuous consumption). The charging current (speed) can be controlled through R34.
Display: LCD with following specification may be used: Color TFT Display with ILI9341 controller, SPI Interface, 16 bit color resolution (RGB565), Backlight diming by software control.
Other Ports: There may be an Audio Aux output that provides lineout for external power amplifier. This output may be used to play tack and bell sounds.

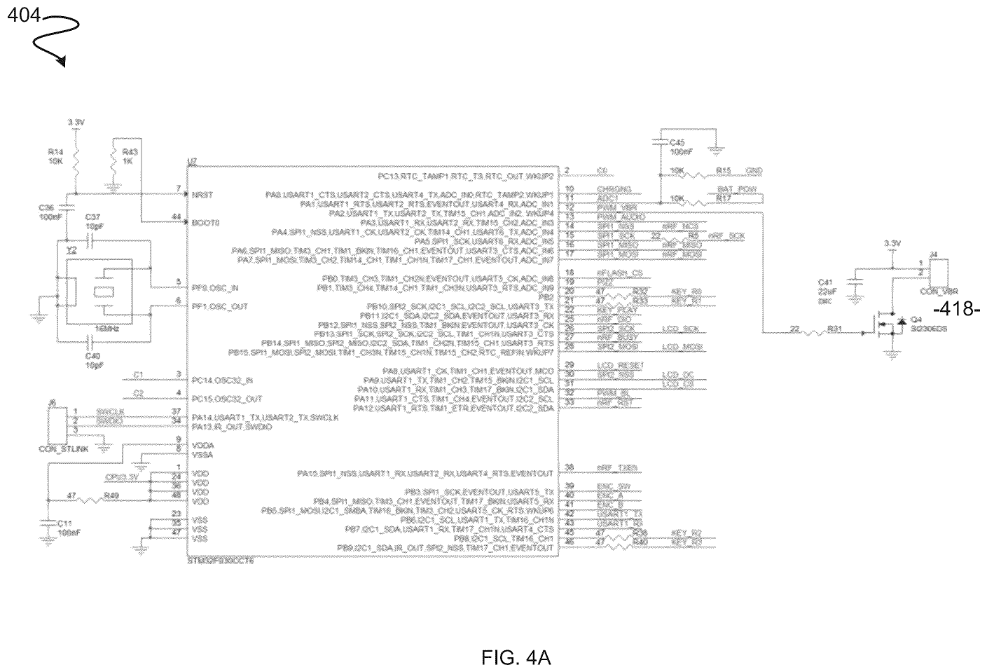

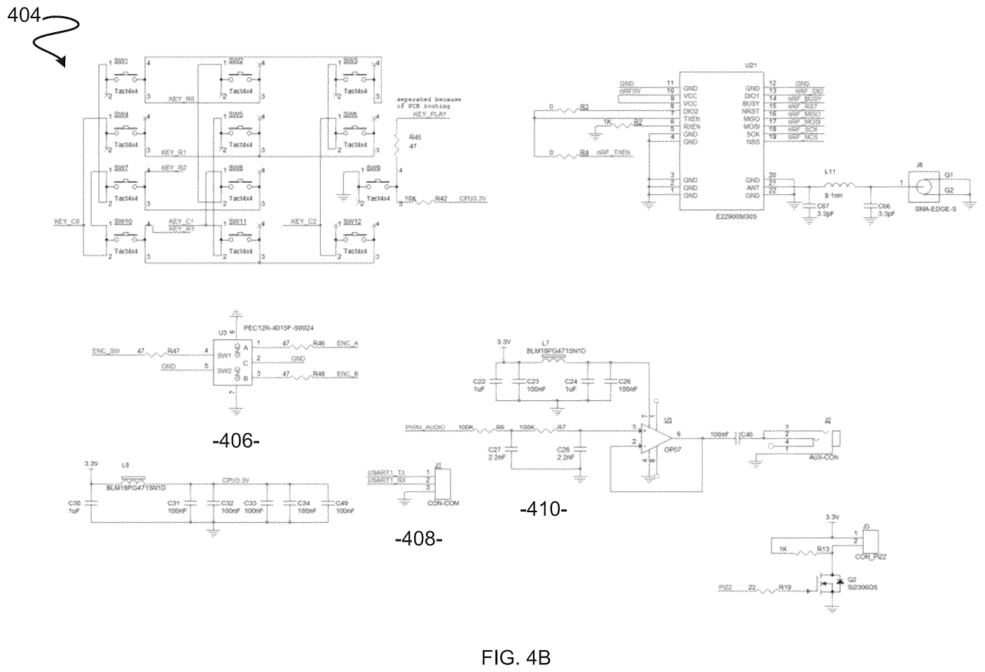

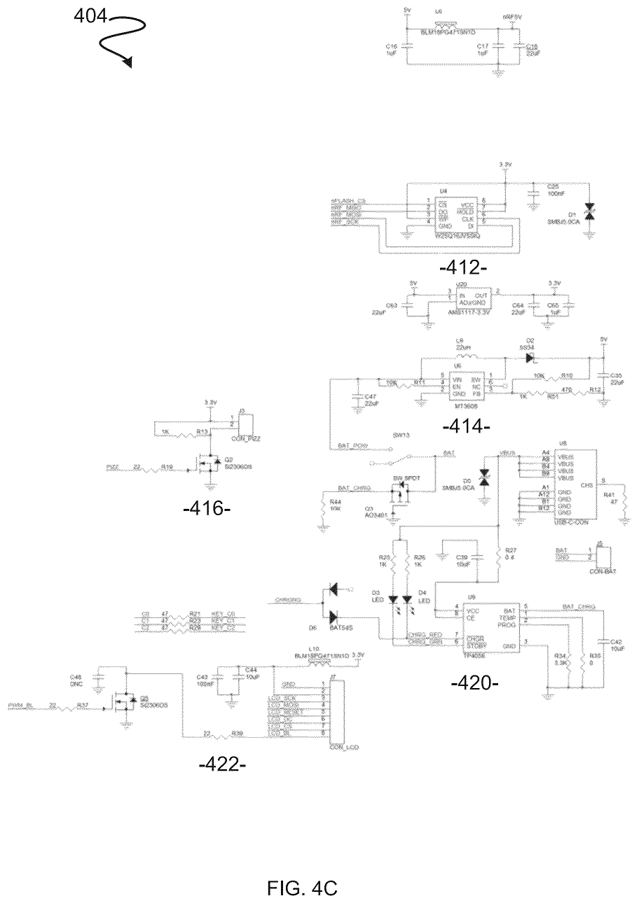

FIGS. 4A to 4C are schematic diagram of haptic device manager 404 according to an example embodiment of the present invention. Haptic device manager 404 comprises: rotary encoder 406, serial debugger 408, AUX filter 410, serial flash 412, boost power regulator 414, optional buzzer 416, vibration output 418, battery charger 420, and LCD interface 422.

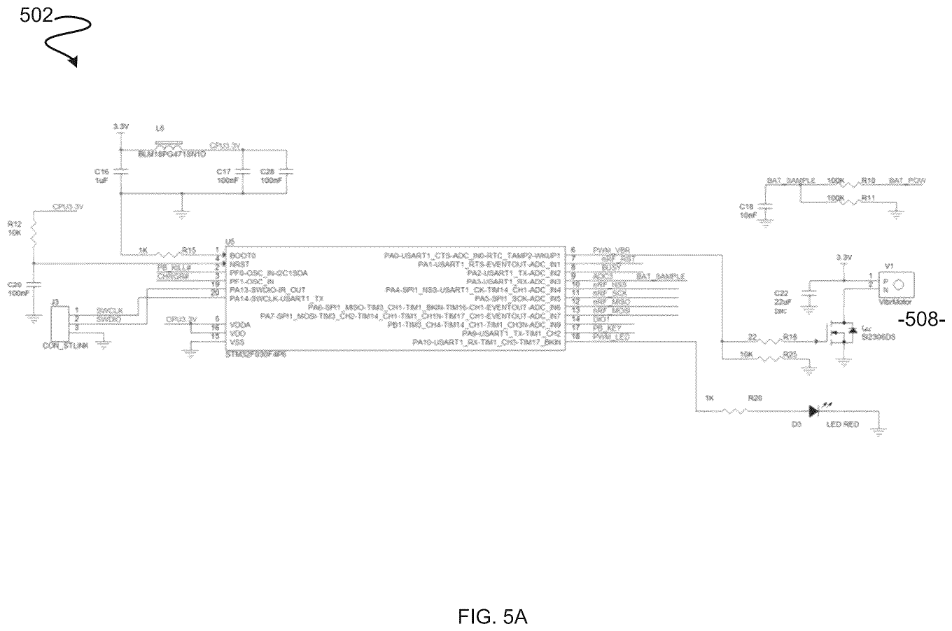

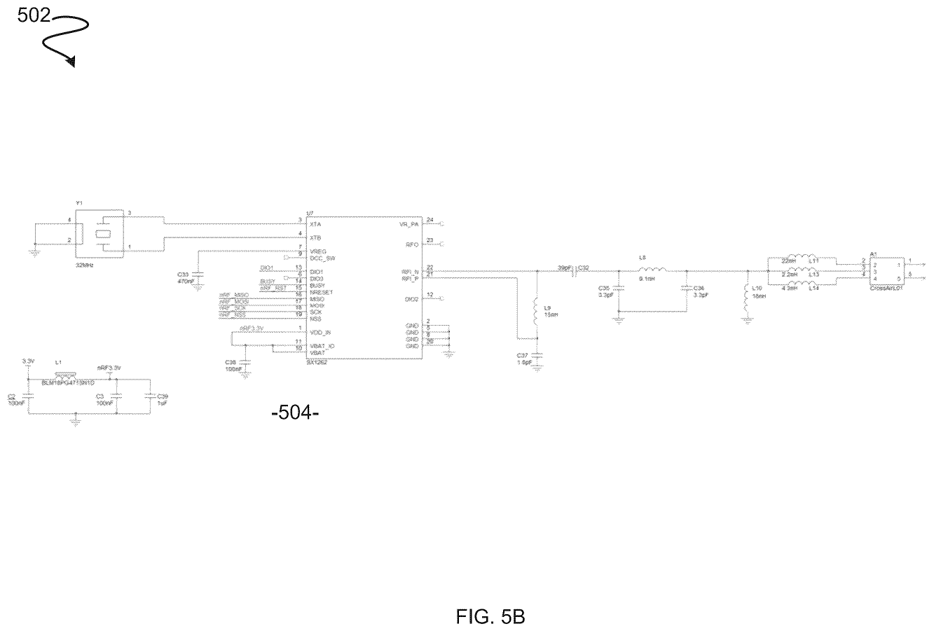

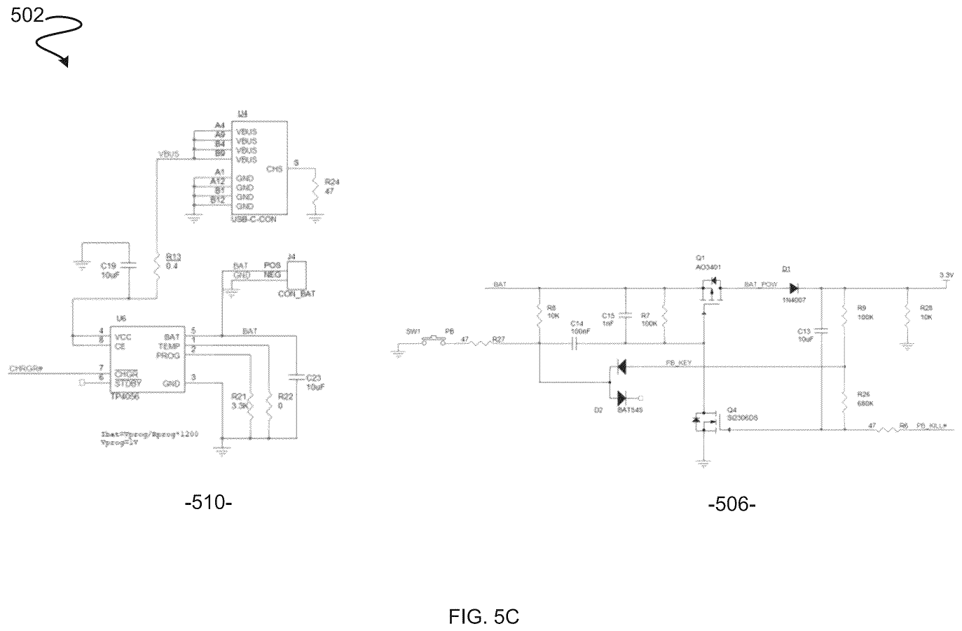

FIGS. 5A to 5C are a schematic diagram of haptic device 502 according to an example embodiment of the present invention. Haptic device 502 comprises: RF module 504, button controller 506, vibration output 508, and battery charger 510.

Some embodiments of the present invention may comprise the following software features:
Master Configuration Page: The page can be accessed by push and holding knob and sync during power on. To change items, knob will scroll over items. Knob push will select the item for change and rotating the know will change the value. Another push on knob will fix the item and finally holding knob will save all values by showing saving progress.
Audio Enabled: Setting this item to “1” will enable audio output tack and bell.
Pre-beat Enabled: Setting this item to “1” will cause pre-beat played before first bell. Number of pre-beats are the same as beats setting.
LCD Backlight: This item change LCD backlight. The result can be seen on the color bar at the bottom of screen in real time.
Screen Timeout: Setting this item to non-zero value will cause screen backlight dime to minimum (not complete dark) when no input from user is sensed.
Wrist Timeout: This parameter will be sent to wristband. Wristband will turn off after, if no activity be in progress for the defined timeout.
RF Channel: This is the working frequency. The resolution is 0.5 MHz.
Tx Power: This is the SX1261 chip output power before the Power Amplifier. The maximum value will result to 30 dBm output.
Spreading: Spreading factor controls the chirp rate. It results increased range but increased airtime.
Bandwidth: It is used bandwidth for communication. More bandwidth decreases airtime but decrease range. Low bandwidths require better crystal accuracy on wristbands.
Lose Bell: It determines how many bells will result one transmission in master.
Lost Bell: It determines how many expected bells must be tolerated in wristband without stopping beats.
Bell and Tack Duration: This item can change vibration duration on wristbands.
Reset Factory: By Setting this item to 1 all items will be reset to factory settings. The item will automatically reset to “0”.
Pairing: On band, holding button for 5 seconds will start pairing mode. It starts with 100 ms led blink and then scanning of all channels. The LED light will start from lowest to highest to show start and end of band scan. Scan will be continued until the master frequency can be found, then led will be on for one second and parameters will be saved and then led will be turned off. On Master side only a click on Sync button is enough (more if all wristbands not paired). Each Sync will send 4 seconds of sync packets (every 50 ms).

One or more embodiments of the present invention may comprise one or more of the following features:
Power Up: Wristband will turn on by pushing the key. LED will light and a 100 ms vibration will show device turn on. The device will turn off after 120 s timeout if no packet received. LED blinks and a 100 ms vibration will be played before turning off. If button be pushed for 2 s, a short blink (20 ms) will show device can be turn off if button released right now. If button keep pushed, it will go to paring state after 5 s (total). If button keep pushed, device will power down after 14 s (emergency power down). After pairing and before shutdown time, there is a test mode.
Timeouts: Master has two kinds of timeout:
Screen timeout: configurable in config page. Dime LCD backlight to a minimum after configured seconds.
Edit Timeout. Removed from config page. Exit edit mode after 30 s. Band will turn off after 120 s if no reception occurs. If device is in pairing mode the timeout will be doubled operation. If device is connected to charger, turn off timeout will be disabled for user for see the charging led. After full charge, the device will turn off. To see the charging LED, user may turn on the device manually. If device receive a packet (play, stop), the device timeout will be updated to the master setting.
Runtime Parameter Editing: In Master holding knob for 2 seconds will activate select mode. Turning knob in this mode will change selection. Pushing knob on any item will activate edit mode for that item. In edit mode turning knob will change parameter value. Pushing knob in edit mode, will activate select mode again. To exit editing mode knob must be held for 2 seconds. Selected item will be shown with two little arrows around the parameter name. Editing parameters can be done during play mode. In this way the result will be effective immediately.
Profile Setting: In Laster any setting can be saved into one of 10 profiles. Setting on screen can be saved by pushing a profile key for 2 s. To recall any profile its key must be pushed. Active profile will be shown on top info bar. During editing the parameters if parameters match any profile setting, the profile number will appear on top. On power up, profile 0 will be activated.
Audio Output: Device will play Tack and Bell sounds, if it is enabled in configuration. Output will need amplifier to be played on speaker. The volume is fixed.

By using LoRa as RF mode, the system may suffer long delays on transmission. Such delays may prevent sending beats close together and/or cause visual delays between send and receive. To compensate for the delay effects, communication between the controller/master and devices/slaves may be augmented in one or more of the following ways.

Sending Bells only: This will help to send less packets and increase the interval between packets. In this mode the wristband has to play the beats by itself. So, the master send enough information to the wristband for automatic beats play. This way the master packets are only used for synchronization and beat information.

Delayed GUI: The second problem with long packets is a visual delay between a master screen displaying a beat and a wristband emitting a vibration. To resolve this delay, the visual update may be delayed by the airtime required for the wristband to receive the transmission. As such, the delay will instead by on the start button reaction.

Firmware may predict the delay based on the configuration and delay the master display accordingly, so that the master display and slave output appear synched in beats. This means the delay will be forced to the starting point. This means when the master play button is pressed, playing of the beat will start after the transmission delay. Wrist beat commences at the end of a packet plus a safety tolerance that compensate for clock difference between the master and the wristband.

Because of low data rate, a master cannot send all the beats. It sends only the bells, start and end. A receiver also may not receive all the packets. It can happen even in close ranges. So, in master there is a possibility of sending all bells or dropping 1, 2 or 3 bell each time. In this way the wrist will play all the beats by itself and use receiving bells to synchronize clocks. This could go to up to 8 missing bells. After that wrist stop beating.

Test Key: Because Wrist beat on its own, it is hard to check the receiving packets at the edge of range. If user push key 6 and 10, a test flag will be sent to wrist and wrist will blink on every received packet. The flag will be cleared when master powered off.

Wrist Crystal Trimming: Master Frequency is trimmed using TCXO. On Wrist a normal crystal is used. Capacitance can be configured in firmware. Accuracy of frequency will increase sensitivity in larger band width. In lower bandwidths it can cause no reception. To measure the frequency, user must hold the wrist button until more than 3 seconds after pairing start. In this state, wrist will transmit 5 times at 915 MHz and the frequency can be seen on spectrum or RTLS SDR. If the frequency was not accurate, a byte in binary file (or in source file) can be changed for tuning the capacitance. Reprograming will be required for new values.

Master Antenna: E22 module have onboard uFL connector. This connector has the best performance if wipe antenna connected to it. PCB antenna can also be connected to this connector. External antenna is considered on Master board through SMA connector. Here is the result of test on these antennas

Some embodiments of the present invention may provide means for synchronizing a beat output by a plurality of wearable metronomes. Such means may include one or more of:
a firmware delay predictor configured to introduce a delay to the start of a beat, wherein the delay accommodates synchronization of the beat across the plurality of wearable metronomes;
a communications protocol configured to accommodate a low wireless data rate, wherein such communications protocol may only transmit bells, a start time, and an end time; and
a method for tuning the timing of two or more wearable metronomes.

Some embodiments of the present invention may provide a wearable apparatus that generates a beat detectable to an individual wearing the apparatus. For example, the apparatus may comprise a wrist-wearable device which vibrates according to the beat. Such a device may be used in one or more of the following applications:
by a musical performer in a musical band, orchestra, choir, or the like, in order to synchronize their performance with other musical performers;
by a dancer performing a dance to synchronize their movements with other dancers;
by a performer with diminished hearing and/or sight to assist in keeping with an otherwise visual and/or auditory beat;
by a participant in a physical activity, such as a sport, yoga, fitness, rowing, synchronized swimming, marching, military marching drills, military training, and the like;
by a patient for rhythm rehabilitation for sensory deprivation;
a audience member watching a fireworks display;
and the like.

### Interpretation of Terms

As used herein, bells may be referred to as timing messages, and vice versa. As further used herein, a haptic device may be referred to as a wristband, and vice versa.

Various embodiments and features of embodiments of the present invention may be described as “synchronous”, “synchronized”, or by synonyms thereof. As used herein, “synchronous”, “synchronized”, and synonyms thereof, may mean less than a variance which is perceptible to an average human engaging in the activity, or less than a variance required for acceptable performance of the activity. For example, the maximum variance between an output of haptic devices 12 used by performers of a musical performance may be the maximum variance between musical notes played by two different sources that is imperceptible to a listener of the two different sources. Such an imperceptible maximum variance may be 100 ms, 30 ms, or 10 ms. In another example, the maximum variance between an output of haptic devices 12 used by performers of a dance performance may be the maximum variance between physical movements of two different dance performers which is imperceptible to an audience member.

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

In addition, while elements are at times shown as being performed sequentially, they may instead be performed simultaneously or in different sequences. It is therefore intended that the following claims are interpreted to include all such variations as are within their intended scope.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A haptic device manager for synchronizing a display output with a plurality of haptic outputs of a respective plurality of haptic devices, the haptic device manager comprising:
a low-power wireless transmitter;
an input device;
a display; and
a controller configured to:
receive a haptic sequence via the input device;
receive a wireless bandwidth of the low-power wireless transmitter via the input device;
determine a timing message and a transmission frequency based on the haptic sequence;
determine a start delay based on the wireless bandwidth and the timing message;
transmit, via the wireless transmitter, the haptic sequence and the timing message to the haptic devices based on the transmission frequency; and
display, via the display, a visual representation of the haptic sequence starting the start delay after the first transmission of the haptic sequence and timing message by the wireless transmitter.

2. The haptic device manager according to claim 1, wherein:
receiving the haptic sequence via the input device comprises:
displaying, via the display, a plurality of haptic sequences; and
receiving, via the input device, a selected one of the plurality of haptic sequences; and
transmitting, via the wireless transmitter, the haptic sequence to the haptic devices comprises:
transmitting, via the wireless transmitter, a haptic sequence identifier to the haptic devices, wherein the haptic sequence identifier corresponds to the selected one of the plurality of haptic sequences.

3. The haptic device manager according to claim 1, wherein the haptic sequence comprises a repeating musical bar having a plurality of beats, the timing message comprises one beat of the plurality of beats, and the timing frequency corresponds to the frequency of the musical bar.

4. The haptic device manager according to claim 1, wherein determining the timing message and the transmission frequency comprises determining the timing message and the transmission frequency based on a maximum variance between the visual representation of the haptic sequence and the plurality of haptic outputs of the respective plurality of haptic devices.

5. The haptic device manager according to claim 1, wherein determining the start delay comprises:
determining a packet size based on the haptic sequence and the timing message;
determining a bitrate based on the wireless bandwidth; and
determining the start delay based on the packet size and the bitrate.

6. The haptic device manager according to claim 1, wherein the low-power wireless transmitter comprises a wireless transmitter with an output power of 30 decibel-milliwatts (dBm) or less, and a frequency band between 902 megahertz (MHz) and 928 MHz.

7. The haptic device manager according to claim 1, wherein the haptic device manager further comprises a haptic output device, and the controller is further configured to output the haptic sequence via the haptic output device starting the start delay after the first transmission of the haptic sequence and timing message by the wireless transmitter.

8. The haptic device manager according to claim 1, wherein:
the input device comprises a twelve-key keypad;
the display comprises a thin-film-transistor liquid-crystal display (TFT LCD) display; and
the haptic device manager further comprises a rechargeable battery power supply, and the power supply powers the input device, display, controller, and low-power wireless transmitter.

9. A synchronous haptic device system comprising a haptic device manager and a plurality of haptic devices, wherein:
the haptic device manager comprises the haptic device manager of claim 1;
each of the haptic devices comprises:
a low-power wireless receiver;
a haptic output device; and
a controller configured to: receive the haptic sequence and the timing message from the low-power wireless transmitter of the haptic device manager, and control the haptic output device based on the haptic sequence and the timing message.

10. The synchronous haptic system of claim 9, wherein:
the haptic sequence comprises a repeating musical bar having a plurality of beats, the timing message comprises one beat of the plurality of beats, and the timing frequency corresponds to the frequency of the musical bar; and
the controller of each of the haptic devices is configured to:
repeatedly output, via the haptic output device, the plurality of beats of the musical bar; and
synchronize a one of the plurality of beats to the timing message.

11. The synchronous haptic system of claim 9, wherein:
the haptic sequence comprises a repeating musical bar having a plurality of beats;
receiving the haptic sequence via the input device comprises:
displaying, via the display, a plurality of musical bars; and
receiving, via the input device, a selected one of the plurality of musical bars;
transmitting, via the wireless transmitter, the haptic sequence to the haptic devices comprises:
transmitting, via the wireless transmitter, a musical bar identifier to the haptic devices, wherein the musical bar identifier corresponds to the selected one of the plurality of musical bars; and
the controller of each of the haptic devices is further configured to:
generate the selected one of the plurality of musical bars from the musical bars identifier;
repeatedly output, via the haptic output device, the plurality of beats of the selected one of the plurality of musical bar; and
synchronize a one of the plurality of beats to the timing message.

12. The synchronous haptic system of claim 9, wherein each of the haptic devices comprises a crystal oscillator having a crystal output frequency, and the controller of each of the haptic devices is further configured to tune the crystal output frequency by adjusting a capacitance of a capacitor connected to the crystal oscillator.

13. The synchronous haptic system of claim 9, wherein the low-power wireless receiver comprises a wireless receiver with a sensitivity of at least −138 decibel-milliwatts (dBm).

14. The synchronous haptic system of claim 9, wherein the haptic devices comprise wrist-wearable haptic devices, and the output of the haptic output devices comprises vibrations.

15. A method of synchronizing a display output of a haptic device manager with a plurality of haptic outputs of a respective plurality of haptic devices, the method comprising:
receiving, via an input device of the haptic device manager, a haptic sequence;
receiving, via the input device of the haptic device manager, a wireless bandwidth of a low-power wireless transmitter of the haptic device manager;
determining, via a controller of the haptic device manager, a timing message and a transmission frequency based on the haptic sequence;
determine, via a controller of the haptic device manager, a start delay based on the wireless bandwidth and the set of timing messages;
transmitting, via the low-power wireless transmitter of the haptic device manager, the haptic sequence and the timing message to the haptic devices based on the transmission frequency; and
displaying, via a display of the haptic device manager, a visual representation of the haptic sequence starting the start delay after the first transmission of the haptic sequence and timing message by the wireless transmitter.

16. The method according to claim 15, wherein:
receiving, via the input device of the haptic device manager, the haptic sequence comprises:
displaying, via the display of the haptic device manager, a plurality of haptic sequences; and
receiving, via the input device of the haptic device manager, a selected one of the plurality of haptic sequences; and
transmitting, via the low-power wireless transmitter of the haptic device manager, the haptic sequence and the timing messages to the haptic devices according to the transmission schedule comprises:
transmitting, via the low-power wireless transmitter of the haptic device manager, a haptic sequence identifier to the haptic devices, wherein the haptic sequence identifier corresponds to the selected one of the plurality of haptic sequences.

17. The method according to claim 15, wherein the haptic sequence comprises a repeating musical bar having a plurality of beats, the timing message comprises one beat of the plurality of beats, and the timing frequency corresponds to the frequency of the musical bar.

18. The method according to claim 15, wherein determining the start delay comprises:
determining, via a controller of the haptic device manager, a packet size based on the haptic sequence and the timing message;
determining, via a controller of the haptic device manager, a bitrate based on the wireless bandwidth; and
determining, via a controller of the haptic device manager, the start delay based on the packet size and the bitrate.

19. The method according to claim 15, further comprising:
receiving, via a low-power wireless receiver of each of the haptic devices, the haptic sequence and the timing message;
outputting, via a haptic output device of each of the haptic devices, the haptic sequence synchronized to the timing message.

20. The method according to claim 19, wherein:
the haptic sequence comprises a repeating musical bar having a plurality of beats;
the timing message comprises one beat of the plurality of beats;
transmitting the haptic sequence to the haptic devices comprises transmitting a musical bar identifier to the haptic devices, wherein the musical bar identifier corresponds to the musical bar; and
outputting the haptic sequence synchronized to the timing message comprises:
generating the musical bar from the musical bar identifier;
outputting the plurality of beats of the musical bar; and
synchronizing a one of the plurality of beats of the musical bar to the timing message.
